(19) United States
(12) Patent Application Publication
(10) Pub. No.: US 2014/0177215 A1
(43) Pub. Date: Jun. 26, 2014

(54) Lighting System

(71) Applicant: TOSHIBA LIGHTING & TECHNOLOGY CORPORATION, Kanagawa (JP)

(72) Inventors: Jun SASAKI, Kanagawa (JP); Hajime OSAKI, Kanagawa (JP)

(73) Assignee: TOSHIBA LIGHTING &TECHNOLOGY CORPORATION, Kanagawa (JP)

(21) Appl. No.: 13/832,731

(22) Filed: Mar. 15, 2013

(30) Foreign Application Priority Data
Dec. 21, 2012 (JP) 2012279805

(51) Int. Cl. F21V 11/00

(52) U.S. Cl. CPC F21V 11/00
USPC 362/231; 362/311.01; 362/235

(57) ABSTRACT

Alighting system includes: a light-discharging portion configured to irradiate a space with light from a duct configured to propagate outside light; a light-diffusing portion disposed so as to cover the light-discharging portion and configured to diffuse light entering an incident surface and going out from a light-emitting surface facing the space; and a light source unit including a light source configured to emit light directed toward the incident surface of the light-diffusing portion. Accordingly, light emission of the light-emitting surface is controlled irrespective of the condition of the outside light and hence desired illumination is realized.

### CROSS-REFERENCE TO RELATED APPLICATION

This application is based upon and claims the benefit of priority from Japanese Patent Application No 2012-279805 filed on Dec. 21, 2012; the entire contents all of which are incorporated herein by reference.

### FIELD

Embodiments described herein relate generally to a lighting system.

### BACKGROUND

In the related art, a light duct system configured to take outside light, specifically sunlight into the interior and light the room interior is developed. The light duct system is configured to achieve lighting using natural light by guiding light taken from a daylight-introducing portion into a house by a duct-shaped light-guiding portion composed of a reflecting surface, and irradiating the room interior therewith from a light-discharging portion.

The system is also developed a system which enables stable illumination irrespective of fluctuation of brightness of the sunlight by arranging the light-discharging portion of the light duct system and a general luminaire on a ceiling surface and illuminating the room interior.

When the light-discharging portions are provided in respective rooms of the interior, there might be a difference of color temperature in light outgoing from the light-discharging portions depending on the difference in route of the light-introducing portion. In order to alleviate the difference in color temperature, a technology is also developed for adjusting the color temperature of light from the light-discharging portion by arranging a color filter in a duct.

However, the light taken from the daylight-introducing portion changes in accordance with a change of a natural environment such as season, time of day, and weather, or an artificial environment, and the color temperature, the color phase, the brightness, and the like of light emitted from the light-discharging portion also change correspondingly. Even though the color filter is provided in the duct, the color of light outgoing from the light-discharging portion cannot be controlled freely, and during the night, the light-discharging portion inevitably becomes a dark portion.

In this manner, in the related art, the color temperature, the color phase, and the brightness of the light outgoing from the light-discharging portion of the light duct system cannot be set freely, and hence there is not only a problem that a user cannot obtain desired illumination, but also a problem that the unnatural impression may be made due to the brightness or the color of the light-discharging portion arranged in the room interior.

### DESCRIPTION OF THE DRAWINGS

FIG. 1 is an explanatory drawing for explaining a lighting system of a first embodiment;

FIG. 2A to FIG. 2F are explanatory drawings illustrating LED arrangement examples in a case where LEDs are employed as light sources 22;

FIG. 3 is a block diagram illustrating an example of a detailed configuration of a light source control unit 40 configured to control the respective light sources 22;

FIG. 4 is an explanatory drawing illustrating a second embodiment;

FIG. 5 is an explanatory drawing illustrating the second embodiment; and

FIG. 6 is an explanatory drawing illustrating a third embodiment.

### DETAILED DESCRIPTION

A lighting system includes a light-discharging portion configured to irradiate a space with light from a duct configured to propagate outside light; a light-diffusing portion disposed so as to cover the light-discharging portion and configured to diffuse light entering an incident surface and going out from a light-emitting surface facing the space; and a light source unit including a light source configured to emit light directed toward the incident surface of the light-diffusing portion.

In some arrangements, the system includes a light source control unit configured to perform dimming control on the light source.

In some arrangements, the light source unit includes a plurality of types of light sources configured to emit lights having two or more color temperatures.

In some arrangements, the light source control unit performs the dimming control on the plurality of types of light sources by type.

In some arrangements, the light source control unit performs the dimming control on the basis of a result of detection of the outside light.

In some arrangements, the light source unit is disposed on the side of the incident surface of the light-diffusing portion.

In some arrangements, the light source unit is disposed in a propagating path for the outside light from the duct to the space.

In some arrangements, the light source includes a plurality of areas configured to emit color lights different from each other.

In some arrangements, the light source control unit causes the light-emitting surface to emit light at a uniform illuminance even during the night.

In some arrangements, the light source control unit causes the light-emitting surface to emit light at a desired color temperature irrespective of the outside light.

Referring now to the drawings, embodiments will be described in detail.

### First Embodiment

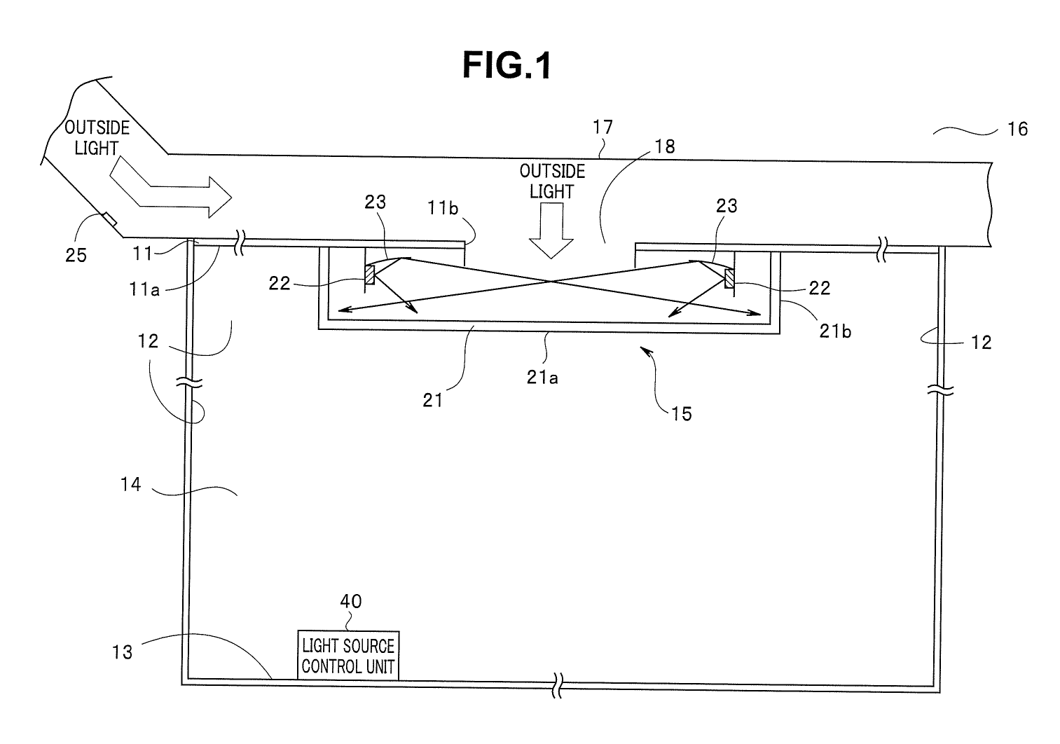

FIG. 1 is an explanatory drawing for explaining a lighting system of a first embodiment.

The lighting system of the first embodiment uses a light duct system employed in various buildings such as houses or facilities. The light duct system includes a daylight-introducing portion configured to introduce the outside light, a light-guiding portion configured to guide the light introduced through the daylight-introducing portion, and a light-discharging portion being an opening provided in the light-guiding portion and configured to irradiate the light from the light-guiding portion. The light duct which constitutes the light-guiding portion extends into respective spaces in the building, and is arranged so as to be capable of irradiating light into the respective spaces via the light-discharging portion's opening toward the respective spaces.

FIG. 1 illustrates an interior space 14, which is one of such spaces. The interior space 14 is a space surrounded by a ceiling surface 11a of a ceiling 11, wall surface 12, and a floor surface 13. A lighting portion 15 is disposed on the ceiling surface 11a. A light duct 17, which is a light-guiding portion, is provided along the ceiling 11 in a space 16 behind the ceiling. The light duct 17 guides the light introduced through the daylight-introducing portion, not illustrated, to the respective rooms, and is a duct-shaped member. The duct-shaped inner surface is formed with a reflecting surface, so that the light introduced through the daylight-introducing portion may be guided to a light-discharging portion 18.

The light-discharging portion 18 is formed of an opening portion provided in the light duct 17, and an opening portion 11b provided in the ceiling 11 having, for example, substantially the same size as the opening. The light-discharging portion 18 is configured to be capable of guiding the light proceeding from the daylight-introducing portion through the light duct 17 to the interior space 14.

In the first embodiment, the lighting portion 15 is disposed so as to cover the light-discharging portion 18, and the interior space 14 is configured to be irradiated with the light passing through the light-discharging portion 18 via the lighting portion 15. The lighting portion 15 includes a light-diffusing plate 21, a plurality of light sources 22, and reflecting plates 23 provided corresponding to the respective light sources 22.

The light-diffusing plate 21 which constitutes a light-diffusing portion is formed into a box shape opening on an upper surface. The light-diffusing plate 21 includes a bottom plate portion 21a and a side plate portion 21b, and the bottom plate portion 21a has a surface area wider than that of the opening portion 11b of the light-discharging portion 18. The light from the light-discharging portion 18 is radiated into the interior space 14 via the light-diffusing plate 21 by mounting an upper end of the side plate portion 21b to the ceiling surface 11a so as to cover the opening portion 11b of the light-discharging portion 18 with the light-diffusing plate 21. The light-diffusing plate 21 diffuses the light entering from the inside and lets the diffused light go out from an outside surface facing the interior space 14 (hereinafter, referred to as a light-emitting surface), and has a function to eliminate uneven brightness on the light-emitting surfaces (surfaces of the bottom plate portion 21a and the side plate portion 21b on the side of the interior space 14) and enhance the uniformity ratio of illuminance.

In the first embodiment, the plurality of light sources 22 are disposed in a space formed between the ceiling surface 11a around the opening portion 11b and the bottom plate portion 21a. Various types of the light sources such as LEDs may be employed as the light sources 22. The reflecting plates 23 configured to direct the light from the light sources 22 mainly onto the bottom plate portion 21a are disposed respectively on the light sources 22 as illustrated by arrows. Accordingly, light from the light-discharging portion 18 and light from the light sources 22 are diffused, and hence uniform light goes out into the interior space 14 side from a light-emitting surface of the light-diffusing plate 21.

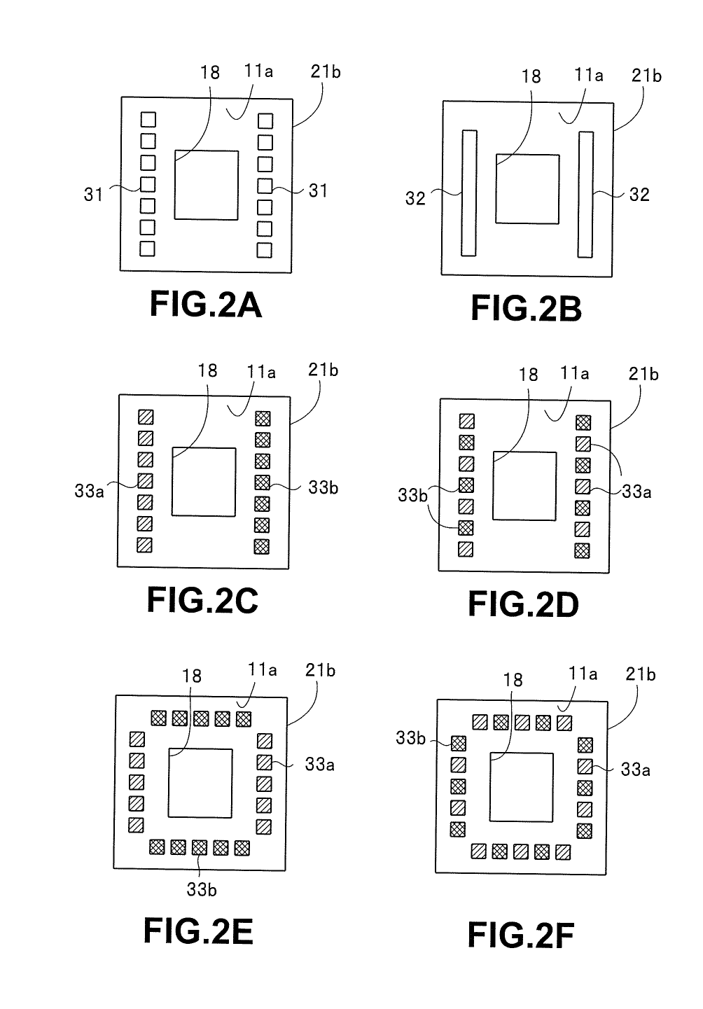

FIG. 2A to FIG. 2F are explanatory drawings illustrating examples of arrangements of the LEDs in a case where LEDs are employed as the light sources 22. In FIG. 1 and FIG. 2A to FIG. 2F, an example in which the light-diffusing plate 21 has a box shape and the bottom plate portion 21a has a square shape is illustrated. However, the light-diffusing plate 21 and the bottom plate portion 21a may have another shape. For example, the bottom plate portion 21a may have a circular shape, and the light-diffusing plate 21 may be formed into a spherical shape. FIG. 2A to FIG. 2F illustrate the arrangement of the LEDs, and illustration of the reflecting plate 23 is omitted.

FIG. 2A illustrates an example in which the LEDs are arranged in two rows. As illustrated in FIG. 2A, LEDs 31 which constitute the light sources 22 are arranged in two rows in a space between the side plate portion 21b of the light-diffusing plate 21 and the light-discharging portion 18. For example, LEDs having lamp color or white color may be employed as the LEDS 31. FIG. 2B illustrates an example in which a straight tube LED lamp 32 is employed instead of the LEDs 31 in FIG. 2A.

FIG. 2C illustrates an example in which LEDs in two colors, e.g., LEDs 33a (with oblique hatching) and 33b (with meshed hatching), are employed as the light sources 22. For example, the LEDs 33a are lamp color LEDs and the LEDs 33b are white LEDs. Although FIG. 2C illustrates an example in which two colors of LEDs are used, three or more colors of LEDs may be used. By controlling light emission of the LED of respective colors, the light having a given color may be irradiated from the light-emitting surface.

FIG. 2D shows an example in which the lamp color LEDs 33a and the white LEDs 33b are arranged alternately. Accordingly, uneven color in the light-emitting surface may be reduced. FIG. 2E and FIG. 2F illustrate examples in which the LEDs 33a and 33b are arranged along four sides of the light-discharging portion 18.

When the respective LEDs employed as the light sources 22 are capable of emitting two colors of light, that is, lamp color and white lights, the light emission from the light-emitting surface at a color temperature corresponding to the color temperature of the sunlight is achieved by controlling the light emission of such LEDs.

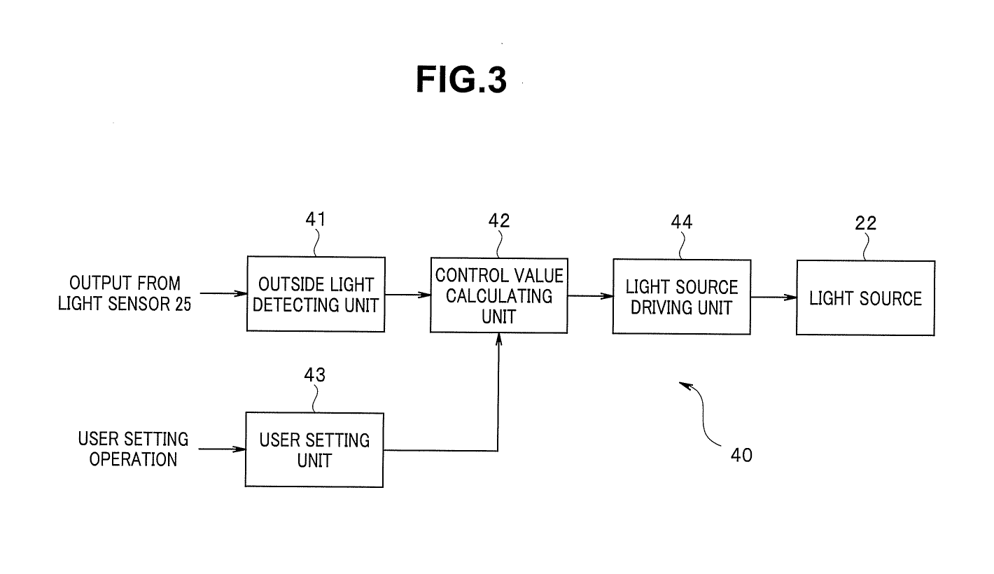

In the first embodiment, the amounts of light of the respective light sources 22 composed of the LEDs may be controlled. FIG. 3 is a block diagram illustrating an example of a detailed configuration of a light source control unit 40 that controls the respective light sources 22. The light source control unit 40 is arranged in a given place, for example, in the interior space 14.

The light duct 17 is provided with a light sensor 25. The light sensor 25 detects the amount of light, the color temperature, the color phase, or the like of the outside light guided into the light duct 17, and outputs the result of detection to an outside light detecting unit 41 of the light source control unit 40. The outside light detecting unit 41 obtains the amount of light, the color temperature, the color phase, or the like from the output from the light sensor 25, and outputs obtained information to a control value calculating unit 42.

A user setting unit 43 is configured to generate a set value on the basis of an operation by the user and output the generated set value to the control value calculating unit 42. For example, the user setting unit 43 is capable of outputting the set value for setting the amount of light and the color temperature of the light from the light-emitting surface to a predetermined amount of light and color temperature. For example, the user setting unit 43 is capable of outputting the set value for changing the amount of light and the color temperature of the light from the light-emitting surface to set values with time.

The control value calculating unit 42 receives the result of detection of the outside light and the set value from the user setting unit 43, obtains a control value for the respective light sources 22 for causing light on the basis of the set value to go out from the light-emitting surface, and outputs the obtained control value to a light source driving unit 44. The light source driving unit 44 turns on the respective light sources 22 on the basis of the control value from the control value calculating unit 42. In this manner, the respective light sources 22 are subjected to lighting control so that the light set by the user is emitted from the light-emitting surface.

The example of the light source control unit 40 which performs the lighting control on the respective light sources 22 in accordance with the output from the light sensor 25 is described. However, the lighting control of the respective light sources 22 may be performed with elapse of time on the basis of a predetermined control value without using the output from the light sensor 25. For example, the light source control unit 40 may perform the lighting control of the light sources so as to emit light having a relatively high color temperature from the light-emitting surface in the morning, and emit light having a relatively low color temperature from the light-emitting surface in the evening. Accordingly, the similar lighting to that of a sunny day is achieved even on a cloudy day.

For example, the light emission of the light-emitting surface is achieved through a change reverse to a normal change of the color temperature of the sunlight by using the output from the light sensor 25. For example, the sunlight in the morning has a relatively high color temperature and the sunlight in the late afternoon has a relatively low color temperature. However, a work-friendly environment may be created by performing the lighting control to lower the color temperature of the light-emitting surface in the morning to avoid too bright lighting and increase the color temperature of the light-emitting surface in the late afternoon.

As described thus far, according to the first embodiment, the light sources are provided in the vicinity of the light-discharging portion of the light duct to cause the light from the light sources to go out through the light-diffusing portion so that the light from the light-discharging portion and the light sources go out from the light-emitting surface of the light-diffusing portion in a state of being diffused. Accordingly, light emission from the light-emitting surface at a desired brightness is achieved irrespective of the condition of the outside light. In addition, since the outside light from the light-discharging portion enters the light-diffusing plate without being interrupted by the light sources, lowering of light-emitting efficiency may be prevented.

Light emission from the light-emitting surface at the brightness and the color temperature that the user wants is also achieved by using light sources emitting two or more colors as the plurality of light sources. For example, the light-emitting surface may be changed at the similar color temperatures to the sunlight with time irrespective of the brightness of the actual outside light or, alternatively, light emission from the light-emitting surface at a constant color temperature irrespective of the condition of the outside light is also possible. Additionally or alternatively, uniform light emission from the light-emitting surface may be achieved with only the light from the light sources, so that even when the amount of light of the sunlight is lowered during the night, for example, lighting of the space with a sufficient amount of light is achieved without providing a feeling of strangeness.

### Second Embodiment

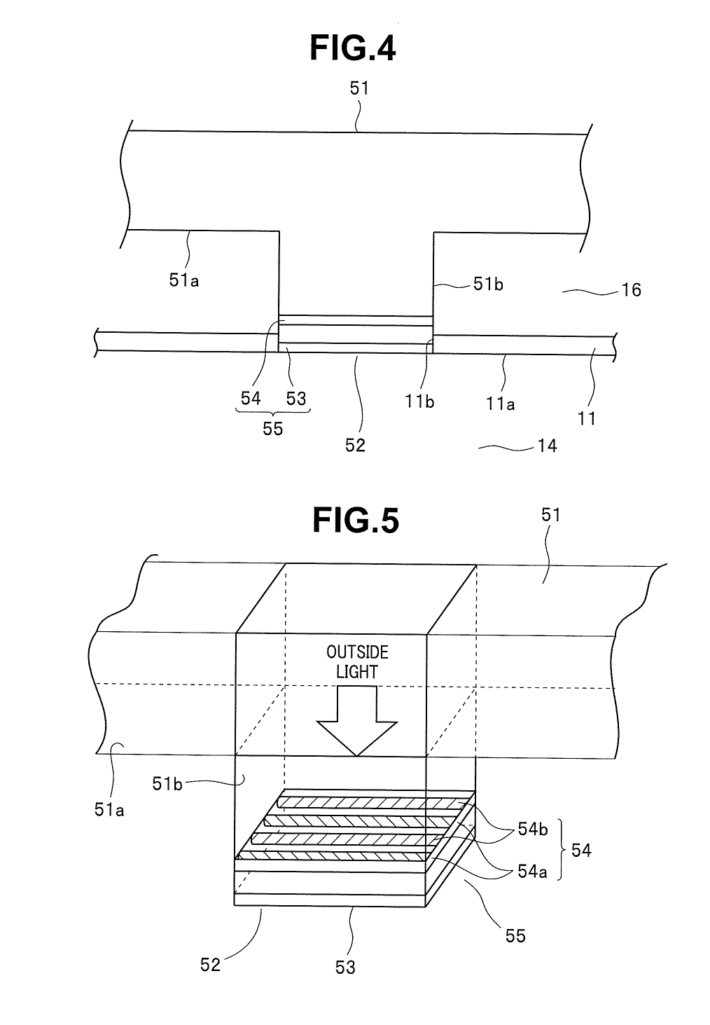

FIG. 4 and FIG. 5 are explanatory drawings illustrating a second embodiment. In FIG. 4 and FIG. 5, common components as those in FIG. 1 are designated by the same signs and description thereof will be omitted. FIG. 4 and FIG. 5 are a cross-sectional view and a perspective view of the lighting system of the second embodiment, respectively.

In the first embodiment, the light sources are arranged above the bottom plate portion in the space other than the space facing the light-discharging portion. In contrast, the second embodiment is an example in which the light sources are arranged between the light-discharging portion and the light-diffusing portion.

In FIG. 4, the interior space 14 is partitioned from the space 16 behind the ceiling by the ceiling 11. A light duct 51, which is a light-guiding portion, is provided along the ceiling 11 in the space 16 behind the ceiling. The light duct guides the light introduced through the daylight-introducing portion, not illustrated, to the respective rooms, and is a duct-shaped member. The duct-shaped inner surface is formed with a reflecting surface, so that the light introduced through the daylight-introducing portion may be guided to a light-discharging portion 52.

In the second embodiment, the light duct 51 includes a horizontal portion 51a and a vertical portion 51b as illustrated in FIG. 4 and FIG. 5. The vertical portion 51b is mounted at one end thereof in an opening portion provided in the horizontal portion 51a and extends from the opening portion toward the interior space 14, for example, vertically downward, and fitted at the other end thereof to the opening portion 11b provided in the ceiling 11.

The light-discharging portion 52 is formed of a lower end opening portion of the vertical portion 51b of the light duct 51 and the opening portion 11b provided on the ceiling 11 having, for example, substantially the same size as the opening portion, and a light-diffusing plate 53 is provided so as to close the light-discharging portion 52.

The light proceeding from the daylight-introducing portion via the horizontal portion 51a and the vertical portion 51b of the light duct 51 is radiated from the light-discharging portion 52 into the interior space 14. In other words, the outside light reaching the light-discharging portion 52 is diffused by the light-diffusing plate 53, and radiated into the interior space 14 as uniform light on the surface of the light-diffusing plate 53 on the interior space 14 side (light-emitting surface).

In the second embodiment, a light source unit 54 is provided on a lower end side of the vertical portion 51b of the light duct 51, and the light source unit 54 and the light-diffusing plate 53 constitute a lighting portion 55. The light source unit 54 includes a plurality of straight tube light sources 54a and 54b arranged substantially horizontally. For example, the straight tube LED lamps may be employed as the straight tube light sources 54a and 54b.

The straight tube light sources 54a and 54b emit light vertically downward, that is, in the direction of the light-diffusing plate 53. The light from the straight tube light sources 54a and 54b enters the light-diffusing plate 53 together with the outside light, and the outside light and the light from the straight tube light sources 54a and 54b are diffused, so that uniform light goes out from the light-emitting surface of the light-diffusing plate 53 to the interior space 14 side.

In FIG. 5, the diameters of the straight tube light sources 54a and 54b are illustrated to be relatively large in comparison with the size of the light duct 51 to facilitate understanding of the drawing. In fact, however, the diameters of the straight tube light sources 54a and 54b are substantially smaller than the size of the light duct 51, and a diameter on the order of 1/100 of the size of the light duct 51, for example, may be employed as the diameters of the straight tube light sources 54a and 54b. Therefore, gaps having a sufficient size are formed between the straight tube light sources 54a and 54b to allow the outside light to pass therethrough, and hence the outside light from the light duct 51 reaches the light-diffusing plate 53 with little interruption by the light source unit 54.

The straight tube light sources 54a and 54b are arranged so as to face the light-diffusing plate 53, and the straight tube light sources 54a and 54b such as the straight tube LED lamps may be configured not to emit light upward. Therefore, no radiation of light from the straight tube light sources 54a and 54b toward the opening portion of the horizontal portion 51a exists, and major part of the light from the straight tube light sources 54a and 54b enters the light-diffusing plate 53 without being damped. Accordingly, in the second embodiment, the light from the straight tube light sources 54a and 54b may be caused to enter the light-diffusing plate 53 efficiently to achieve light emission from the light-emitting surface.

The light source unit 54 is provided in the vertical portion 51b of the light duct 51. In other words, since the light source unit 54 is provided in a plane of the vertical portion 51b of the light duct 51 and above the ceiling surface 11a, the planer size of the lighting portion 55 may be reduced to the size of the duct, and the light-emitting surface may be configured to be flush with the ceiling surface 11a.

In the second embodiment as well, the amounts of light from the straight tube light sources 54a and 54b may be controlled by the light source control unit 40 (see FIG. 1). The light source control unit 40 is configured to control the amounts of light of the respective straight tube light sources 54a and 54b, in some arrangements, on the basis of the output from the light sensor 25 (not illustrated) provided on the light duct 51 or the setting operation performed by the user. Accordingly, in the second embodiment as well, the brightness and the color temperature of the light-emitting surface may be controlled by the light from the light source unit 54 irrespective of the outside light guided by the light-discharging portion 52.

In the second embodiment as well, not only the straight tube lamps generating the color light of the same color, but also the straight tube lamps generating lights of two or more different colors may be employed as the plurality of straight tube light sources 54a and 54b. For example, a color light at a given color temperature may be radiated from the light-emitting surface by arranging the straight tube light sources 54a having a lamp color and the straight tube light sources 54b having a white color alternately and controlling the light emission of the straight tube light sources 54a and 54b independently from each other.

A straight tube lamp generating lights of different colors by area in the longitudinal direction may also be employed as the straight tube light sources 54a and 54b. When the straight tube light sources 54a and 54b having such a configuration are employed, the color light having a given color temperature may be radiated from the light-emitting surface as in the case where the straight tube light sources 54a and 54b of the same type are used.

In this manner, according to the second embodiment as well, the same effect as that of the first embodiment is achieved. For example, the light from the light-emitting surface may be adjusted so as to substantially match the sunlight by adjusting the color temperature by performing dimming control on the respective straight tube light sources independently, or a desired illuminance may be obtained only by an artificial light even when the brightness of the sunlight is lowered during the night without changing the appearance of the light-discharging portion. In the second embodiment, the straight tube light sources are arranged in the midsection of the route of the light from the light duct to the light-discharging portion. Accordingly, the light from the straight tube light sources may be directed toward the light-diffusing plate efficiently to be radiated from the light-emitting surface to the room interior space.

### Third Embodiment

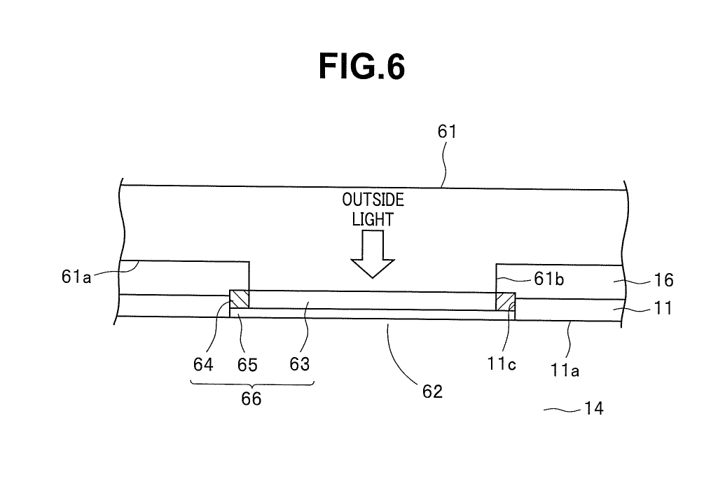

FIG. 6 is an explanatory drawing illustrating a third embodiment. In FIG. 6, common components as those in FIG. 1 are designated by the same signs and description thereof will be omitted. FIG. 6 illustrates a cross-sectional structure of the lighting system of the third embodiment.

In the first embodiment, the light sources are arranged above the bottom plate portion in the space other than the space facing the light-discharging portion. In contrast, the third embodiment is an example in which the light sources are arranged in the vicinity of the light-discharging portion outside of the light-discharging portion.

In FIG. 6, the interior space 14 is partitioned from the space 16 behind the ceiling by the ceiling 11. A light duct 61, which is a light-guiding portion, is provided along the ceiling 11 in the space 16 behind the ceiling. The light duct guides the light introduced through the daylight-introducing portion, not illustrated, to the respective rooms, and is a duct-shaped member. The duct-shaped inner surface is formed with a reflecting surface, so that the light introduced through the daylight-introducing portion may be guided to a light-discharging portion 62.

In the third embodiment, the light duct 61 includes a horizontal portion 61a and a vertical portion 61b. The vertical portion 61b is mounted at one end thereof in an opening portion provided in the horizontal portion 61a and extends downward in the vertical direction toward the interior space 14 from the opening portion, and constitutes at the other end thereof the opening portion which faces an opening portion 11c provided in the ceiling 11.

The light-discharging portion 62 is formed of a lower end opening portion of the vertical portion 61b of the light duct 61 and the opening portion 11c provided on the ceiling 11 has a slightly larger size corresponding to the opening portion, and a lighting portion 66 is provided so as to close the light-discharging portion 62.

The lighting portion 66 includes a light-guiding plate 63 configured to close the lower end opening portion of the vertical portion 61b of the light duct 61, a plurality of light sources 64 mounted on both side surfaces of the light-guiding plate 63, and the light-diffusing sheet 65 provided on a surface of the light-guiding plate 63 on the side of the interior space 14. The light-guiding plate 63 is a plate-shaped member having the same shape in plan view as the opening shape of the lower end opening portion of the vertical portion 61b of the light duct 61 and, for example, the shape in plan view of the light-guiding plate 63 is a square shape like the examples illustrated in FIG. 2A to FIG. 2F. In FIG. 6, an example of the square-shaped light-guiding plate 63 as described above is illustrated, and the plurality of light sources 64 are disposed respectively along the two side surfaces facing each other from among the four side surfaces of the light-guiding plate 63.

The light-guiding plate 63 and the light-diffusing sheet 65 constituting the light-diffusing portion have transparency, and light passing through the lighting portion 66 are little attenuated. Various types of light sources such as LEDs may be employed as the light sources 64.

The light proceeding from the daylight-introducing portion via the horizontal portion 61a and the vertical portion 61b of the light duct 61 is guided to the interior space 14 via the light-guiding plate 63 and the light-diffusing sheet 65 of the lighting portion 66 provided on the light-discharging portion 62. In other words, the outside light reaching the light-discharging portion 62 from the light duct 61 passes through the light-guiding plate 63, is diffused by the light-diffusing sheet 65, and is radiated into the interior space 14 as uniform light in the surface of the light-diffusing sheet 65 on the interior space 14 side (light-emitting surface).

In the third embodiment, the plurality of light sources 64 provided on the both side surfaces of the light-guiding plate 63 are configured to be capable of irradiating the inside of the light-guiding plate 63 with light from the side surfaces of the light-guiding plate 63. The light-guiding plate 63 has a reflecting portion, not illustrated, formed by printing, or a reflecting portion formed to have a rough shape, so that light entering from the side surfaces may be caused to go out downward substantially over the entire surface thereof.

Incident light from the light sources 64 provided on the both side surfaces of the light-guiding plate 63 is guided substantially downward in the vertical direction over the entire surface of the light-guiding plate 63. The light from the light sources 64 guided downward in the vertical direction by the light-guiding plate 63 is diffused together with the outside light in the light-diffusing sheet 65, and is radiated from the light-emitting surface into the interior space 14 as uniform light.

Since a major part of the lighting portion 66 may be provided in the vertical portion 61b of the light duct 61 and the light sources 64 may be provided in a plane of the vertical portion 61b of the light duct 61 and above the ceiling surface 11a, the planer size of the lighting portion 66 may be reduced sufficiently, and the light-emitting surface may be configured to be flush with the ceiling surface.

In the third embodiment as well, the amount of light from the light sources 64 may be controlled by the light source control unit 40 (see FIG. 1). The light source control unit is configured to control the amount of light of the respective light sources 64, in some examples, on the basis of the output from the light sensor 25 (not illustrated) provided on the light duct 61 or the setting operation performed by the user. Accordingly, in the third embodiment as well, the brightness and the color temperature of the light-emitting surface may be controlled by the light from the light source unit 64 irrespective of the outside light guided to the light-discharging portion 62.

In the third embodiment as well, not only lamps generating the color light of the same color, but also lamps generating light of two or more different colors may be employed as the plurality of light sources 64. For example, a color light at a given color temperature may be radiated from the light-emitting surface by arranging the LEDs having a lamp color and the LEDs having a white color alternately as the light sources 64 and controlling the light emission of the LEDs independently from each other.

The LEDs 31, 32, 33a, and 33b in FIG. 2A to FIG. 2F, the straight tube LED lamp, or the like may be employed as the light sources 64, and these LEDs may be arranged as needed on a given surface of the side surfaces of the light-guiding plate 63. Furthermore, a straight tube lamp generating lights of different colors by respective areas in the longitudinal direction may be employed as the light sources 64.

In this manner, in the third embodiment as well, the same effect as those of the respective embodiments described above is achieved. In the third embodiment, the light sources are arranged outside of the route of the light from the light duct to the light-discharging plate, and the outside light passes only through the light-guiding portion and the light-diffusing sheet in the light-discharging portion, so that the attenuation of the outside light at the time of passage through the lighting portion may be sufficiently suppressed.

In the embodiments described above, the example in which the light-discharging portion is provided in the ceiling is described. However, the light-discharging portion may be provided in a wall to diffuse the outside light and the light from the light sources from the wall surface by the light-diffusing portion and radiate the same into the space as uniform light.

Although the example in which the light-diffusing sheet is used is described, the light-diffusing portion may be formed by applying a diffusing process on the light-guiding plate instead of using the light-diffusing sheet.

The invention of the present application is not limited to the embodiments described above as is, and various modifications may be made without departing from the scope of the invention in the stage of implementation. The embodiments described above include various steps of the invention, and various modifications may be extracted by a suitable combination of a plurality of constituent features disclosed herein. For example, the problems described in the Background may be solved and the advantageous effects described herein may be achieved even when several constituent features are deleted from all the constituent features disclosed in the embodiments, the configuration after the deletion of the above-described constituent features may also be extracted as the invention.

While certain embodiments have been described, these embodiments have been presented by way of example only, and are not intended to limit the scope of the inventions. Indeed, the novel systems described herein may be embodied in a variety of other forms; furthermore, various omissions, substitutions and changes in the form of the systems described herein may be made without departing from the spirit of the inventions. The accompanying claims and their equivalents are intended to cover such forms or modifications as would fall within the scope and spirit of the inventions.

What is claimed is:

1. A lighting system comprising:
a light-discharging portion configured to irradiate an interior space with light from a duct configured to propagate outside light;
a light-diffusing portion disposed so as to cover the light-discharging portion and configured to diffuse light entering an incident surface and exiting from a light-emitting surface facing the interior space; and
a light source unit including a light source configured to emit light directed toward the incident surface of the light-diffusing portion.

2. The lighting system of claim 1, further including:
alight source control unit configured to perform dimming control on the light source.

3. The lighting system of claim 1, wherein
the light source unit includes a plurality of types of light sources configured to emit light having two or more color temperatures.

4. The lighting system of claim 1, wherein
the light source unit is disposed on a side of the incident surface of the light-diffusing portion.

5. The lighting system of claim 1, wherein
the light source unit is disposed outside a propagating path for the outside light from the duct to the interior space.

6. The lighting system of claim 1, wherein
the light source unit is disposed in the propagating path for the outside light from the duct to the interior space.

7. The lighting system of claim 1, wherein
the light source includes a plurality of areas configured to emit lights of different.

8. The lighting system of claim 2, wherein
the light source control unit performs the dimming control based on a detection of the outside light.

9. The lighting system of claim 2, wherein
the light source unit is disposed on a side of the incident surface of the light-diffusing portion.

10. The lighting system of claim 2, wherein
the light source unit is disposed outside a propagating path for the outside light from the duct to the interior space.

11. The lighting system of claim 2, wherein
the light source unit is disposed in the propagating path for the outside light from the duct to the interior space.

12. The lighting system of claim 3, wherein
the light source control unit performs the dimming control on the plurality of types of light sources by type.

13. The lighting system of claim 12, wherein
the light source control unit performs the dimming control based on detection of the outside light.

14. The lighting system of claim 8, wherein
the light source control unit causes the light-emitting surface to emit light at a uniform illuminance irrespective of time of day.

15. The lighting system of claim 8, wherein
the light source control unit causes the light-emitting surface to emit light at a desired color temperature irrespective of the outside light.

16. The lighting system of claim 13, wherein
the light source control unit causes the light-emitting surface to emit light at a uniform illuminance irrespective of time of day.

17. The lighting system of claim 13, wherein
the light source control unit causes the light-emitting surface to emit light at a desired color temperature irrespective of the outside light.

18. A lighting system, comprising:
a light-discharging portion configured to irradiate an interior space with light from a duct configured to propagate outside light;
a light-diffusing portion disposed so as to cover the light-discharging portion and configured to diffuse light entering an incident surface and exiting from a light-emitting surface flush with a ceiling of the interior space and facing the interior space;
a light source unit including a light source configured to emit light toward the incident surface of the light-diffusing portion; and
a light source control unit configured to adjust the light source.

19. The lighting system of claim 18, wherein adjusting the light source includes adjusting the color temperature.

20. The lighting system of claim 18, wherein the light source includes a first LED having a first color and a second LED having a second color different from the first color.

21. The lighting system of claim 20, wherein the light source control unit adjusts the light source by controlling the first LED independently from the second LED.

22. The lighting system of claim 18, wherein the light source includes at least two straight tube lights extending across the light-discharging portion.

23. The lighting system of claim 18, wherein the light source control unit causes the light-emitting surface to emit light at a uniform illuminance irrespective of time of day.

24. The lighting system of claim 18, wherein the light source control unit causes the light-emitting surface to emit light at a desired color temperature irrespective of the outside light.

25. A lighting system, comprising:
a light-discharging portion configured to irradiate an interior space with light from a duct configured to propagate outside light;
a light-diffusing portion extending over the light-discharging portion and configured to diffuse light entering an incident surface and exiting from a light-emitting surface facing the interior space; and
a light source unit including a light source configured to emit light toward the incident surface of the light-diffusing portion; and
a light source control unit configured to adjust the light source based on detection of outside light.

26. The lighting system of claim 25, wherein the light source includes a plurality of LEDs.

27. The lighting system of claim 26, wherein the plurality of LEDs include at least one LED of a first color and at least one LED of a second color different from the first color.

28. The lighting system of claim 27, wherein the light source control unit adjusts the light source by adjusting the at least one LED of the first color independently from the at least one LED of the second color.

29. The lighting system of claim 25, wherein the detection of outside light on which the adjustment of the light source is based includes an input received from an outside light sensor.

30. The lighting system of claim 25, wherein the light source control unit causes the light-emitting surface to emit light at a uniform illuminance irrespective of time of day.

31. The lighting system of claim 25, wherein the light source control unit causes the light-emitting surface to emit light at a desired color temperature irrespective of the outside light.
